(19) United States
(12) Patent Application Publication
(10) Pub. No.: US 2005/0052970 A1
(43) Pub. Date: Mar. 10, 2005

(54) Recording medium, recording device, recording method, and recording program

(75) Inventor: Keiji Katata, Tokorozawa-shi (JP)

Correspondence Address: MORGAN LEWIS & BOCKIUS LLP, 1111 PENNSYLVANIA AVENUE NW, WASHINGTON, DC, 20004, US

(73) Assignee: PIONEER CORPORATION

(21) Appl. No.: 10/913,492

(22) Filed: Aug. 9, 2004

(30) Foreign Application Priority Data
Aug. 7, 2003 (JP) P2003-206524

(51) Int. Cl. G11B 5/09; G11B 7/24

(52) U.S. Cl. 369/47.21; 369/59.25; 369/59.23

(57) ABSTRACT

A recording medium capable of preventing recording quality from deteriorating due to repeated overwriting is provided. Recording marks and spaces which are formed based on recording information generated by combining desired content information and additional information that changes whenever the content information is recorded in an overwritable recording medium to thus record the content information.

### BACKGROUND OF THE INVENTION

1. Field of the Invention

The present invention relates to a recording medium, a recording device, a recording method, and a recording program.

2. Description of the Related Art

In an overwritable recording medium (hereinafter, referred to as a recording medium), such as a phase change recording medium represented by a DVD-RW, recording marks are formed by changing the crystal structure in the recording surface of the recording medium to thus record desired content information.

In order to record the content information in the recording medium, the content information is divided into a plurality of sectors and is subjected to error-correction coding and modulation. Also, based on a recording format generated by adding a sync code as synchronization information, the recording portions of the recording marks or spaces are formed to thus record the content information.

In addition, it is stipulated that the sync code is synchronization information for specifying a starting end and a terminating end of each of the divided content information items and includes a sign (hereinafter, referred to as a sync detector) for identification, which is defined by a combination of 14T and 4T.

In the above-mentioned conventional art, when some of the contents of the content information are the same, the edges of the recording marks formed so as to represent the information on the portions in which the contents of the content information are the same may overlap. In this case, physical properties deteriorate in the positions where the edges on the recording medium overlap. When physical properties of the corresponding positions significantly deteriorate due to the repeated overwriting, it is not possible to distinguish the recording marks or the spaces.

Accordingly, the present invention is made to solve the above problems.

### SUMMARY OF THE INVENTION

The above object of the present invention can be achieved by an overwritable recording medium of the present invention. The overwritable recording medium is provided with: desired content information; additional information that changes whenever the content information is recorded in the recording medium; and a plurality of recording patterns which are formed based on recording information generated by combining the desired content information and the additional information.

According to the present invention, even if a part of the content information is the same, since a physical sector is changed in accordance with changes in the additional information and since recording marks and spaces are formed based on the corresponding the physical sector, it is possible to prevent the edges of the recording marks and the spaces from overlapping, to prevent the edges of the recording marks and the spaces from being blurred, and to thus significantly improve the quality of a DVD-RW.

In one aspect of the present invention can be achieved by the recording medium of the present invention. The recording medium of the present invention is, wherein the recording information is generated by the content information and the additional information that changes based on random numbers, and wherein the recording patterns are formed based on the generated recording information.

According to the present invention, since the additional information is generated based on the random numbers, it is possible to change the contents of the additional information at random and to further enhance the above-mentioned operational effects.

In another aspect of the present invention can be achieved by the recording medium of the present invention.

In another aspect of the present invention can be achieved by the recording medium of the present invention. The recording medium of the present invention is, wherein the recording information is generated by combining the content information and the additional information by error-correction coding, and wherein the recording patterns are formed based on the generated recording information.

According to the present invention, since it is possible to change parities of outer code and parities of inner coded generated by the error-correction coding in accordance with changes in the additional information and to thus change the physical sector, it is possible to further enhance the above-mentioned operational effects.

In further aspect of the present invention can be achieved by the recording medium of the present invention. The recording medium of the present invention is, wherein the recording information is generated by performing modulation after the error-correction coding is made, and wherein the recording patterns are formed based on the recording information.

According to the present invention, since it is possible to further change the physical sector by the 8/16 modulation and to thus enhance the above-mentioned operation effects.

The above object of the present invention can be achieved by a recording device for recording desired content information in an overwritable recording medium of the present invention. The recording device for recording desired content information in an overwritable recording medium, the recording device is provided with: a recording information generating device which generates recording information for combining the content information and the additional information that changes whenever the content information is recorded in the recording medium; and a recording pattern forming device which forms a plurality of recording patterns in the recording medium based on the recording information.

According to the present invention, even if a part of the content information is the same, since a physical sector is changed in accordance with changes in the additional information and since recording marks and spaces are formed based on the corresponding the physical sector, it is possible to prevent the edges of the recording marks and the spaces from overlapping, to prevent the edges of the recording marks and the spaces from being blurred, and to thus significantly improve the quality of a DVD-RW.

The above object of the present invention can be achieved by a method of recording desired content information in an overwritable recording medium of the present invention. The method of recording desired content information in an overwritable recording medium, the method is provided with: a recording information generating process of generating recording information for combining the content information and the additional information that changes whenever the content information is recorded in the recording medium; and a recording pattern forming process of forming a plurality of recording patterns in the recording medium based on the recording information.

According to the present invention, even if a part of the content information is the same, since a physical sector is changed in accordance with changes in the additional information and since recording marks and spaces are formed based on the corresponding the physical sector, it is possible to prevent the edges of the recording marks and the spaces from overlapping, to prevent the edges of the recording marks and the spaces from being blurred, and to thus significantly improve the quality of a DVD-RW.

### BRIEF DESCRIPTION OF THE DRAWINGS

FIG. 1 is a diagram illustrating the structure of an information recording surface of a DVD-RW according to the present embodiment;

FIG. 2 is a schematic diagram illustrating the structure of a unit sector in a data sector according to the present embodiment;

FIG. 3 is a schematic diagram illustrating the structure of an additional information region according to the present embodiment;

FIG. 4 is a schematic diagram illustrating the structure of an ECC block according to the present embodiment;

FIG. 5 is a schematic diagram illustrating the structure of a recording sector according to the present embodiment;

FIG. 6 is a schematic diagram illustrating the structure of a physical sector according to the present embodiment;

FIG. 7A is a diagram illustrating a modulation table used for 8/16 modulation according to the present embodiment;

FIG. 7B is a diagram illustrating a modulation table used for 8/16 modulation according to the present embodiment;

FIG. 8 is a diagram illustrating the pattern of conventional sync codes;

FIG. 9A is a diagram illustrating the patterns of sync codes according to the present embodiment;

FIG. 9B is a diagram illustrating the patterns of sync codes according to the present embodiment;

FIG. 10 is a block diagram illustrating the schematic structure of a recording and reproducing device according to the present embodiment;

FIG. 11 is a flowchart illustrating the order of a recording process of content information according to the present embodiment; and

FIG. 12 is a flowchart illustrating the order of a reproducing process of content information according to the present embodiment.

### DESCRIPTION OF THE PREFERRED EMBODIMENTS

Embodiments of the present invention are described with reference to the drawings. According to the embodiments described below, the present invention is applied to a DVD-RW as a recording medium.

(1) Recording Medium

First, the structure of a DVD-RW as a recording medium according to the present embodiment is described. Hereinafter, after describing the structure of the information recording surface of the DVD-RW, the recording format of the content information to be recorded in the information recording surface is described in detail.

(1-1) Structure of Information Recording Surface

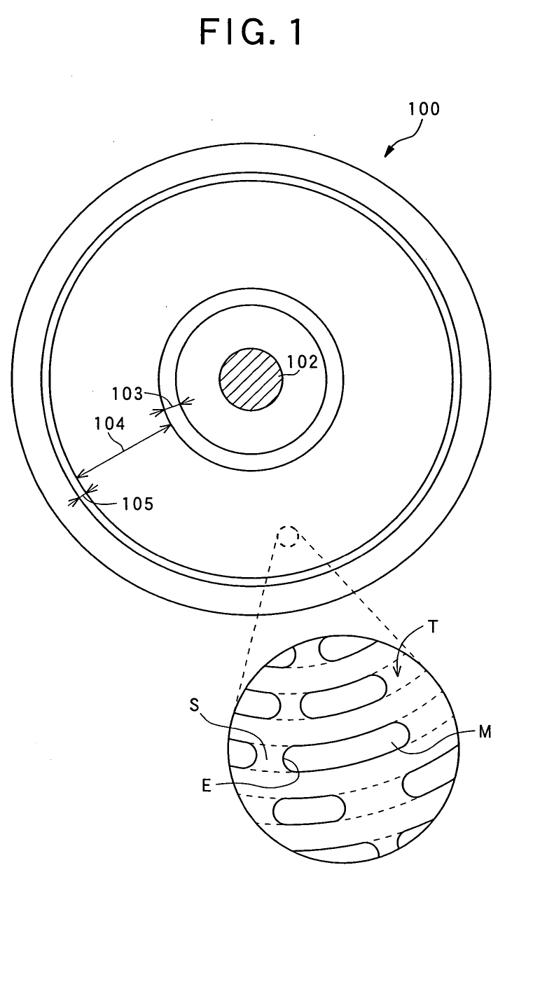

First, the structure of the information recording surface of the DVD-RW is described with reference to FIG. 1. FIG. 1 illustrates the structure of the information recording surface of the DVD-RW.

As illustrated in FIG. 1, the information recording surface of a DVD-RW 100 includes a clamping hole 102 for fixing the DVD-RW 100 in its center and includes a lead-in region 103, a data recording region 104, and a lead-out region 105 outside the clamping hole 102 in the order. One continuous recording track T is formed in the lead-in region 103, the data recording region 104, and the lead-out region 105. A plurality of recording portions such as recording marks M and spaces S, which represent the contents of the recorded information, are formed in the recording track T.

The lead-in region 103 is first accessed during the recording and reproducing operations of the DVD-RW 100. Various information items on information on the DVD-RW 100 and the content information are recorded in the lead-in region 103. The data recording region 104 records the content information such as image information or voice information. The content information to which additional information is added and which is modulated is recorded in the data recording region 104.

Further, the recording format of the content information recorded in the data recording region 104 is mentioned later.

In addition, the lead-out region 105 is a region subsequent to the data recording region 104. Information for identifying the lead-out region 105 is recorded in the lead-out region 105.

Furthermore, edges E of the recording marks M and the spaces S are described as follows. The edges E of the recording marks M and the spaces S refer to the ends of the recording portions that are the recording marks M and the spaces S, that is, boundaries between the recording marks M and the spaces S adjacent to the recording marks M. In the DVD-RW 100, since the recording portions that represent the recording marks M and the spaces S are formed by changing the crystal structure, boundaries between crystalline portions that are the recording marks M and amorphous portions that are the spaces S are the edges E. For example, the recording marks M and the spaces S according to the present embodiment constitute the recording portions according to the present invention.

(1-2) Recording Format of Content Information

The recording format of the content information is described in detail.

First, a sector that is a recording unit of information recorded in the DVD-RW 100 is described. The sector is composed of a data sector, a recording sector, and a physical sector in accordance with steps of error correction coding and modulation of the content information before recording in a disk. The data sector is a basic sector composed of main data as the content information, sector numbers, etc. The recording sector is obtained with error correction coding by scrambling the respective data items of the data sector. The physical sector is obtained by modulating the recording sector into a frame structure.

The recording formats of the respective sectors are described as follows.

(1-2-1) Data Sector

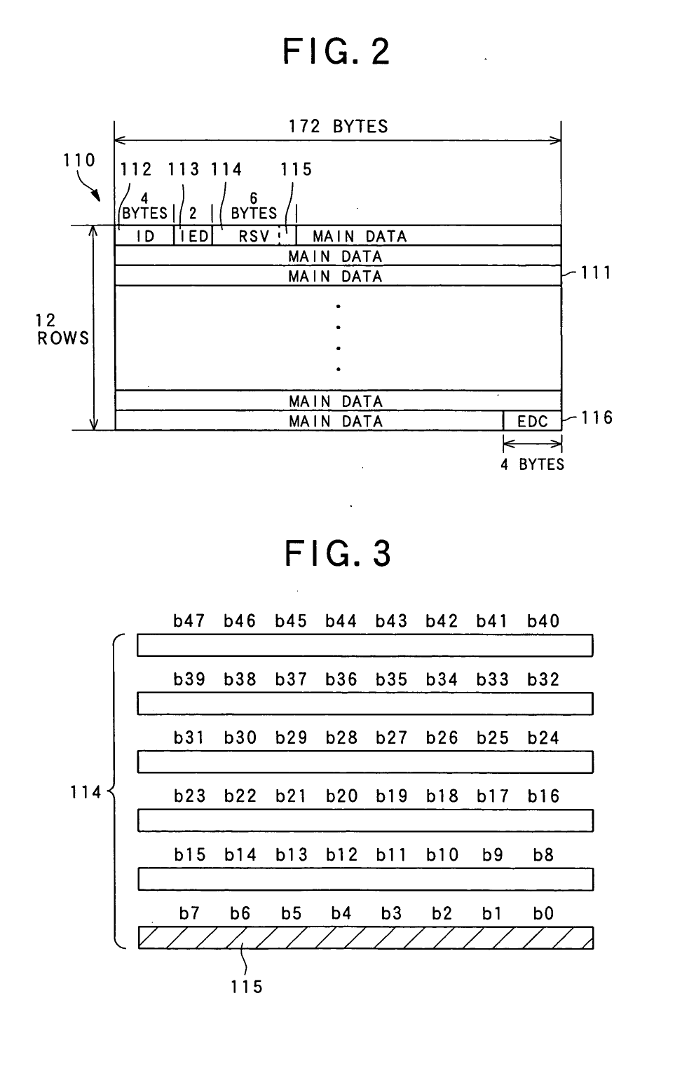

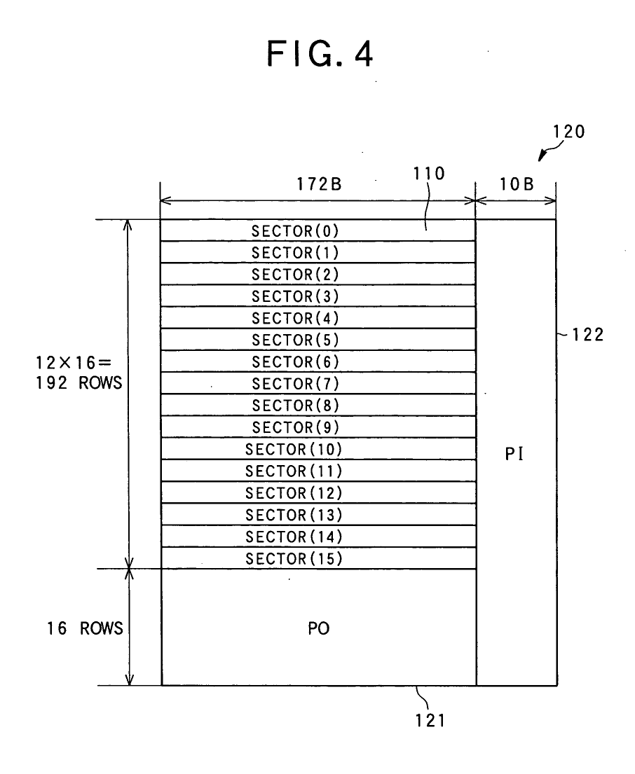

First, the data sector are described with reference to FIGS. 2 to 4. FIG. 2 is a schematic diagram illustrating the structure of a unit sector of the data sector. FIG. 3 is a schematic diagram illustrating the structure of an additional information region. FIG. 4 is a schematic diagram illustrating the structure of an ECC block.

First, as illustrated in FIG. 2, a unit sector 110 of the data sector has an array structure of 172 bytes×12 rows. Respective regions such as an identification data (ID) region 112, an ID error detection code (IED) region 113, and a reserve (RSV) region 114 are added to the front of the main data region for recording main data. In addition, an error detection code (EDC) region 116 is added to the end of the main data region. The ID region 112 is a region to record information such as sector numbers, layers to which sectors belong. The IED region 113 is a region to record an error detecting parity of ID. In addition, the RSV region 114 is a region to record system reservation data such as copy protection information. According to the present embodiment, a part of the RSV region 114 is an additional information region 115. Additional information based on random numbers is set in the additional information region 115. In addition, the EDC region 116 is a region to record an error detecting parity of the entire data sector.

As illustrated in FIG. 3, the additional information region 115 is provided in a part of the RSV region 114. That is, the additional information region 115 is provided in 8 bits (1 byte) from b0 to b7 in the RSV region 114 defined by 48 bits (6 bytes) from b0 to b47. Also, as mentioned above, the additional information based on random numbers is substituted in the additional information region 115. To be specific, as mentioned later, an encoder of a recording and reproducing device generates random numbers and the information (the additional information) in which the random numbers are represented by the binary system is placed in the additional information region 115. Therefore, the additional information varies whenever the content information is recorded.

After adding the ID, the IED, the RSV, the additional information, and the EDC to the respective regions, scrambling is performed in the unit sector 110 by pseudo noise (PN) series data addition. Also, 16 units of the unit sector 110 are combined to form an error checking and correcting (ECC) block after performing error correction coding.

As illustrated in FIG. 4, the ECC block 120 has an array structure in which a parity of the outer code (PO) of 16 rows and a parity of the inner code (PI) of ten columns are added to the array of 172 bytes×192 rows formed by the 16 continuous unit sectors 110. The parities are generated by adding a PO parity 121 of 16 bytes to the 172 columns and by adding a PI parity 122 of 10 bytes to the 208 rows including the PO parity 121. Also, since the PO parity 121 and the PI parity 122 are Reed-Solomon product-like code, they may be generated in the reverse order of the above process.

Here, each of the PO parity 121 changes in accordance with the contents of the information recorded in a column to be encoded. Also, each of the PI parity 122 changes in accordance with the contents of the information recorded in a row to be encoded. Therefore, the PO parity 121 and the PI parity 122, which are associated with encoding of the additional information region 115 as an object to be encoded, change in accordance with the change in the additional information recorded in the additional information region 115. Further, as mentioned above, since the additional information changes whenever the content information is to be recorded, even when information (that is, the content information) other than the additional information is the same, the PO parity 121 and the PI parity 122 associated with the encoding of the additional information region 115 change.

That is, when the contents of the content information are partially the same before and after overwriting the content information in the DVD-RW 100, the contents of the additional information region 115 and the PO parity 121 and the PI parity 122 that are associated with the encoding of the additional information region 115 in the ECC block 120 corresponding to the portion where the contents of the corresponding content information are the same are different before and after overwriting the content information. To be specific, in one ECC block 120, before and after overwriting the content information, 2,928 bytes that are the sum of 16 bytes of the additional information region 115, 16×172 bytes of the PO parity 121, and 160 bytes of the PI parity 122 vary.

(1-2-2) Recording Sector

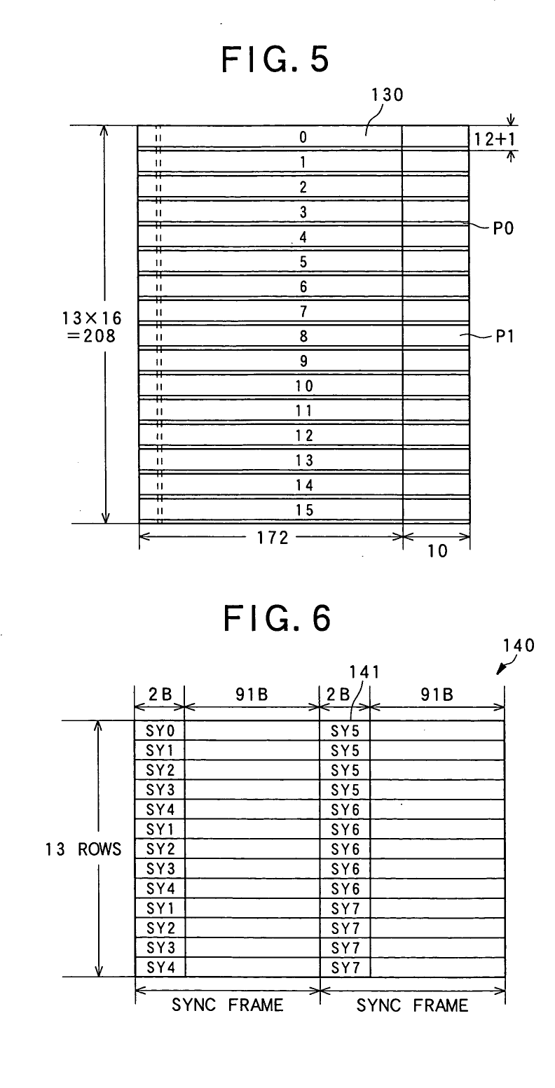

Next, the recording sector is described with reference to FIG. 5. FIG. 5 is a schematic diagram illustrating the structure of a recording sector.

The recording sector 130 is generated by interleaving each row of PO parity 121 of 16 rows in the last line of each sector in the ECC block 120.

As illustrated in FIG. 5, the recording sector 130 has the array structure of 182 bytes×13 (12+1) rows in which one row of the PO parity 121 is added to the last line of each sector of 12 rows. As mentioned above, it is possible to arrange the PO parity 121 that changes in accordance with changes in the additional information so that the rows of the PO parity 121 are dispersed in the ECC block 120 by interleaving the PO parity 121 and to significantly change the array of codes after 8/16 modulation as mentioned later. Therefore, it is possible to further reduce the overlapping of the edges E of the recording marks M and the spaces S before and after overwriting the content information.

(1-2-3) Physical Sector

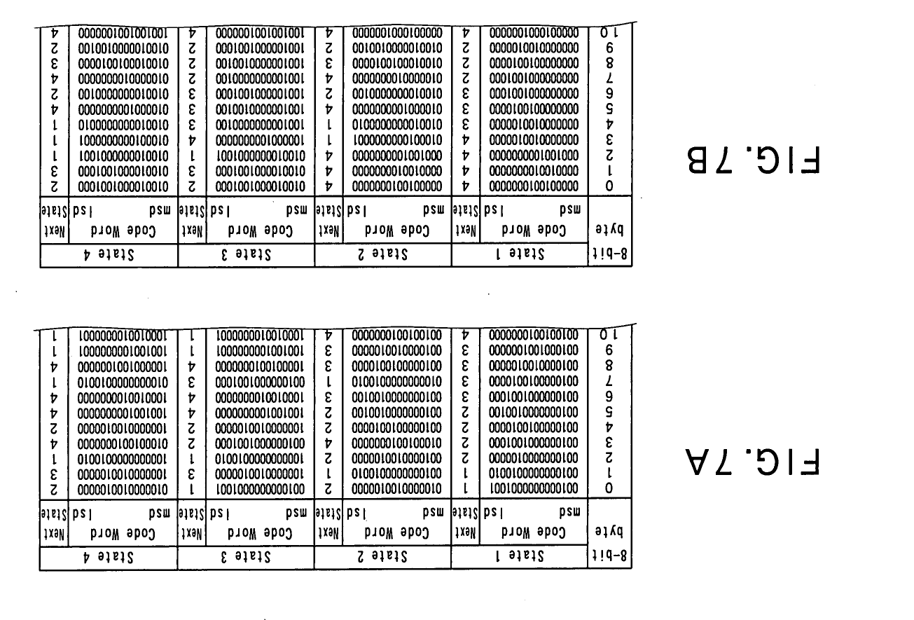

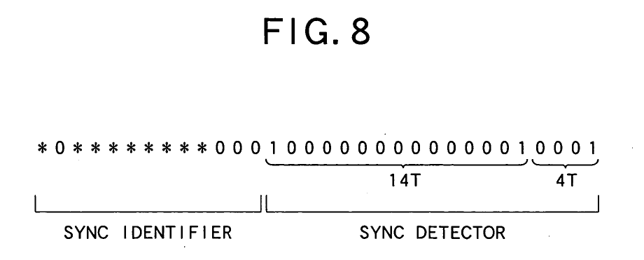

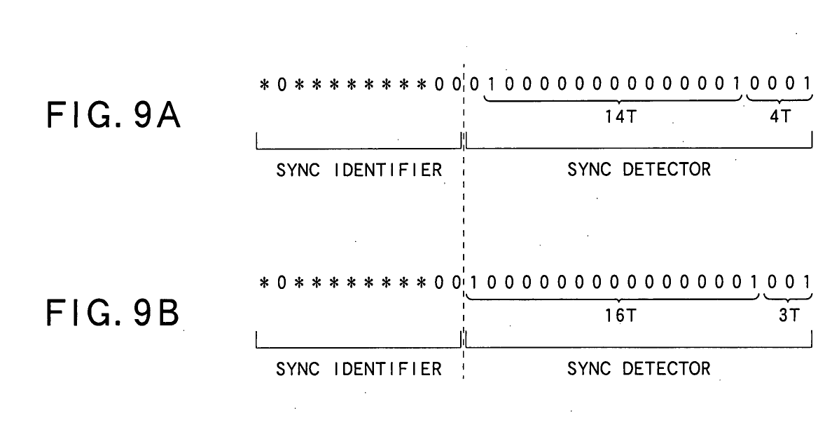

Next, the physical sector is described with reference to FIGS. 6 to 9. FIG. 6 is a schematic diagram illustrating the structure of the physical sector. FIGS. 7A and 7B are diagrams illustrating a modulation table used for the 8/16 modulation. FIG. 8 is a diagram illustrating the pattern of conventional sync codes. FIGS. 9A and 9B are diagrams illustrating the patterns of sync codes according to the present embodiment.

After the above-mentioned recording sector 130 is subject to 8/16 modulation, each of the rows is divided into two and sync codes 141 are added to the fronts of the divided rows to thus generate a physical sector 140.

As illustrated in FIG. 6, the physical sector 140 has a structure in which the sync codes 141, each having 2 bytes, are added to the fronts of the regions divided into two, each having 91 bytes.

The 8/16 modulation and the sync codes 141 are described in detail.

(A) 8/16 Modulation

First, the 8/16 modulation is described.

The 8/16 modulation is performed using the modulation table illustrated in FIGS. 7A and 7B. As illustrated in FIGS. 7A and 7B, the modulation table is composed of two conversion tables having a main conversion table and a sub-conversion table. In the respective conversion tables, different 16 bit codes are assigned to 8 bit data. And, the 8/16 modulation is performed by converting the 8 bit data as original data into corresponding 16 bit codes based on the modulation tables.

The aforementioned modulation table defines a 16 bit code so that the number of consecutive 0s between code bits 1 and 1 after performing the 8/16 modulation is basically no less than 2 and no more than 10. Since the recording marks M and the spaces S are formed based on the 16 bit code after performing the 8/16 modulation in the DVD-RW 100, when one channel bit width is T, the smallest length of mark/space of the recording marks M and the spaces S is 3T and the largest length of mark/space of the recording marks M and the spaces S is 11T.

In addition, as illustrated in FIGS. 7A and 7B, in the respective conversion tables, four different 16 bit codes represented as States 1 to 4 are assigned to one 8 bit data item. Therefore, the number of 16 bit codes used for forming the recording marks M and the spaces S increases to thus prevent the edges E of the recording marks M and the spaces S from overlapping before and after overwriting the content information and to thus prevent the recording surface of the DVD-RW 100 from deteriorating due to the repeated writing of the edges E in the same position.

However, for example, when 0 continues as original data, Next State of State 1 with respect to 0 of 8 bit data is 1, the alignment of 16 bit data of State 1 with respect to 0 of the 8 bit data is repeatedly recorded. Both before overwriting the content information and after overwriting the content information, when the same number continues as original data, there is a high possibility of overlapping the edges E of the recording marks M and the spaces S. Therefore, in such a case, it is not possible to sufficiently prevent the recording surface of the DVD-RW 100 from deteriorating only by assigning a plurality of states to one 8 bit data item as mentioned above.

Therefore, as mentioned above, it is possible to prevent the edges E of the recording marks M and the spaces S from overlapping by changing the additional information region 115, the PO parity 121, and the PI parity 122 before and after overwriting the content information even when some contents of the content information are the same before and after overwriting the content information by recording the additional information that changes in the additional information region 115.

(B) Sync Code

Next, the sync codes 141 are described.

The sync codes 141 are information for performing synchronization when the information recorded in the DVD-RW 100 is read. The corresponding sync codes 141 include sync detectors defined by codes distinguishable from the content information.

First, a conventional sync code is described with reference to FIG. 8. FIG. 8 illustrates the pattern of the conventional sync code. Asterisk (*) illustrated in FIG. 8 represents 0 or 1.

As illustrated in FIG. 8, the conventional sync code changes in accordance with balance with the information right before the position to which the sync code is to be added and is composed of a sync identifier for specifying the position of the sync code in the ECC block and a sync detector for detecting that the corresponding information is the sync code.

In particular, the sync detector is defined by a kind of combination of 14T and 4T. The corresponding information is recognized as the sync code and is detected by the sync detector.

Next, the sync codes 141 according to the present embodiment are described with reference to FIGS. 9A and 9B. FIGS. 9A and 9B are diagrams illustrating the patterns of the sync codes according to the present embodiment. Similar to FIG. 8, asterisk (*) illustrated in FIGS. 9A and 9B represents 0 or 1.

As illustrated in FIGS. 9A and 9B, the sync codes 141 according to the present embodiment are composed of the sync identifiers and the sync detectors like the conventional sync code 141 illustrated in FIG. 8. As mentioned above, the sync detector of the conventional sync code 141 is defined by a kind of combination of 14T and 4T. On the other hand, the sync detectors of the sync codes 141 according to the present embodiment are defined by two kinds of combinations of 14T and 4T (FIG. 9A) and 16T and 3T (FIG. 9B).

In the sync codes 141 having the sync detectors defined as two kinds of patterns, as mentioned later, any one is selected based on the immediately preceding potential level (0 or 1). For example, when the immediately preceding potential level is 0, the sync code 141 including the sync detector formed by the combination of 14T and 4T is selected. When the immediately preceding potential level is 1, the sync codes 141 including the sync detector formed by the combination of 16T and 3T are selected.

As mentioned above, since the sync codes 141 including different sync detectors based on an immediately preceding potential level are selected, it is possible to make the sync codes 141 different before and after overwriting the content information and to reduce by half the possibility of overlapping the edges E of the recording marks M and the spaces S that represent the sync detectors of the sync codes 141.

Furthermore, as the sync detectors are defined as two kinds of patterns, however, it may be defined by patterns no less than three. For example, it is possible to define the sync detectors by three kinds of patterns such as the combination of 14T and 4T, the combination of 16T and 3T, and the combination of 18T and 3T. In this case, since the scope of selection of the sync detectors also increases, it is possible to further reduce the possibility of overlapping the edges E of the recording marks M of the sync detectors before and after overwriting the content information.

In addition, according to the present embodiment, the sync detectors are formed by two combinations of channel bit width T. However, the sync detectors according to the present embodiment may be formed so that any one channel bit width T in the corresponding sync detectors is fixed and that the other channel bit width T different from the fixed channel bit is changed. For example, the corresponding sync detectors may be defined by two kinds of patterns such as the combination of 14T and 3T and the combination of 14T and 4T.

In general, sync codes have a fixed channel bit length over the entire corresponding sync codes as mentioned above so as to be distinguished from the content information. Therefore, any one channel bit width T in the sync detectors is fixed so that, when the channel bit length of all the corresponding sync detectors increases and decreases, the channel bit length of all the sync identifiers changes.

That is, since the channel bit length of all the sync identifiers changes by changing only the channel bit width T different from the fixed channel bit width T, it is possible to change the recording positions of the recording marks M or the spaces S of the respective channel bit widths T in the sync detectors.

Therefore, although any one channel bit width T in the sync detectors is fixed and then the channel bit widths in the corresponding sync detectors are formed as mentioned above, it is possible to reduce the overlapping of the edges E of the recording marks M and the spaces S that represent the sync detectors whenever the content information is overwritten, to prevent the edges E of the recording marks M and the spaces S from being blurred, and to thus significantly improve recording quality as mentioned later.

Based on the physical sector 140 mentioned above, the recording marks M and the spaces S are formed on the recording track T of the DVD-RW 100 to thus record the content information.

As mentioned above, in the recording medium according to the present embodiment, the additional information region 115 for recording the additional information that changes whenever the content information is recorded is provided, and the PO parity 121 and the PI parity 122 associated with the encoding of the additional information region 115 are changed. Then, the physical sector 140 is generated after 8/16 modulation. Since the recording marks M and the spaces S are formed based on the physical sector 140, even if a part of the content information is the same before and after overwriting the content information, it is possible to make the shapes of the recording marks M and the spaces S corresponding to the additional information region 115, the PO parity 121, and the PI parity different, to reduce the overlapping of the edges E of the recording marks M and the spaces S whenever the content information is overwritten, to prevent the edges E of the recording marks M and the spaces S from being blurred, and to thus significantly improve the recording quality.

In addition, in the recording medium according to the present embodiment, since the sync codes 141 include the sync detectors defined as two kinds of patterns, it is possible to selectively add the sync codes 141 having sequentially different sync detectors, to reduce overlapping of the edges E of the recording marks M and the spaces S that represent the sync detectors whenever the content information is overwritten, to prevent the edges E of the recording marks M and the spaces S from being blurred, and to thus significantly improve the recording quality.

(2) Recording and Reproducing Device

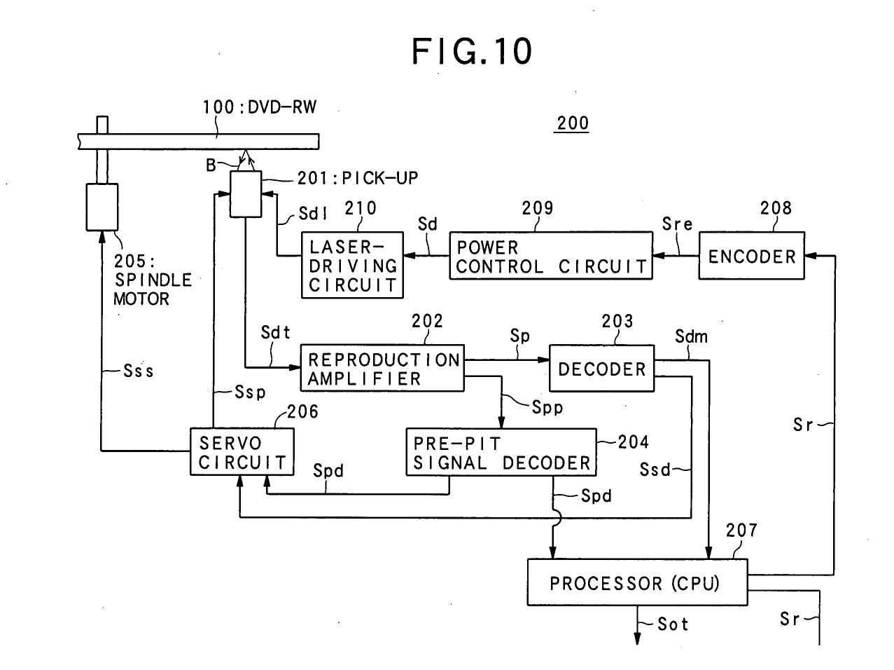

Next, a recording and reproducing device 200 for recording and reproducing the content information such as music information and image information in the DVD-RW 100 are described with reference to FIG. 10. FIG. 10 is a block diagram illustrating the schematic structure of the recording and reproducing device 200 according to the present embodiment.

As illustrated in FIG. 10, the recording and reproducing device 200 according to the present embodiment includes a pick-up 201, a reproduction amplifier 202, a decoder 203, a pre-pit signal decoder 204, a spindle motor 205, a servo circuit 206, a processor 207, an encoder 208, a power control circuit 209, and a laser driving circuit 210.

The pick-up 201 includes a laser diode, a polarizing beam splitter, an objective lens, and a photodetector, which are not shown, radiates a light beam B onto the information recording surface of the DVD-RW 100 based on a laser-driving signal Sdl, and outputs a pre-pit or a detection signal Sdt of the previously recorded information based on the reflected light.

The reproduction amplifier 202 amplifies the pre-pit or the detection signal Sdt of the previously recorded information, which is output from the pick-up 201, outputs a pre-pit signal Spp, and outputs an amplified signal Sp of the previously recorded information.

The decoder 203 detects the sync detectors by the amplified signal Sp to specify the sync codes 141, to generate the physical sector 140, to perform the 8/16 demodulation of the physical sector 140, and to thus generate the recording sector 130, and interleaves the PO parity 121 in the recording sector 130 to thus generated the data sector so that a demodulated signal Sdm and a servo-demodulated signal Ssd are outputted.

The pre-pit signal decoder 204 decodes the pre-pit signal Spp to thus output a demodulated pre-pit signal Spd.

The servo circuit 206 outputs a pick-up servo signal Ssp for controlling a focus servo and a tracking servo in the pick-up 201 based on the demodulated pre-pit signal Spd and the servo-demodulated signal Ssd and outputs a spindle servo signal Sss for servo controlling the rotation of the spindle motor 205 for rotating the DVD-RW 100.

Parallel with these, the processor 207 detects a pre-pit based on the demodulated pre-pit signal Spd, reads address information on the DVD-RW 100, and detects a recording position on the DVD-RW 100 in which data is to be recorded based on the address information. In addition, the processor 207 temporarily stores a recording signal Sr of data to be recorded, which is inputted from the outside and outputs the recording signal Sr to the encoder 208 based on the address information. Further, the recording and reproducing device 200 according to the present embodiment can reproduce the data recorded in the DVD-RW 100. At that time, a reproduced signal Sot is outputted to the outside through the processor 207 based on the demodulated signal Sdm.

The encoder 208 forms a data sector based on the data that is obtained from the recording signal Sr and sets additional information based on random numbers in the additional information region 115 provided in a part of the data sector 110. And, the encoder 208 adds the PI parity 122 and the PO parity 121 to the data block formed in the data sector 110 to thus form the ECC block 120, interleaves the PO parity of the corresponding ECC block 120 to thus generate the recording sector 130, inserts the sync codes 141 into the recording sector 130 and performs 8/16 modulation of the recording sector 130 to thus generate the physical sector 140, and outputs an encoded signal Sre based on the corresponding physical sector 140. Further, in order to insert the sync codes 141 into the recording sector 130, the encoder 208 determines to insert the sync code 141 having any one sync detector of the sync detectors defined by two kinds of patterns based on the information immediately before the position into which the sync code 141 is inserted, and inserts the determined sync code 141 into the recording sector 130. The encoder 208 functions as, for example, part or the whole of recording information generating means in the recording and reproducing device 200.

The laser driving circuit 210 drives the laser diode based on the driving signal Sd to thus output a laser-driving signal Sdl for emitting the light beam B. Therefore, the pick-up 201, the power control circuit 209, and the laser driving circuit 210 function as, for example, part or the whole of recording portion forming means in the recording and reproducing device 200.

(3) Processing in Recording and Reproducing Device

Next, a recording process of recording the content information in the DVD-RW 100 using the recording and reproducing device 200 having the above-mentioned structure and a reproducing process of reproducing the content information recorded in the DVD-RW 100 are described as follows.

(3-1) Recording Process

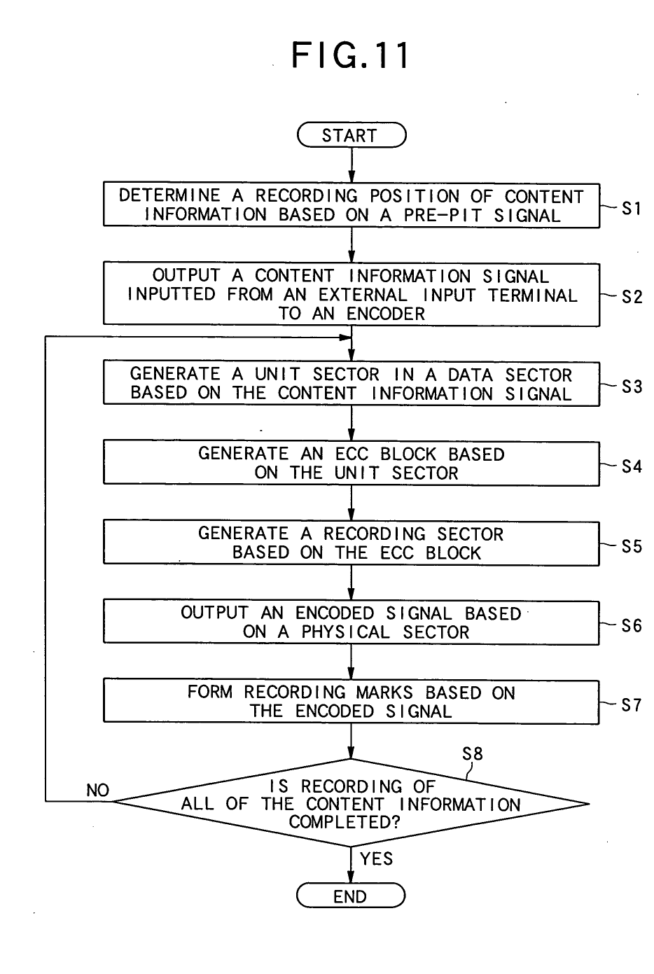

First, the recording process of recording the content information in the DVD-RW 100 using the recording and reproducing device 200 are described with reference to FIG. 11. FIG. 11 is a flowchart illustrating the procedure of a recording process of content information.

As illustrated in FIG. 11, the processor 207 of the information recording device 200 detects a pre-address based on the pre-pit signal of the DVD-RW 100 to thus determine the recording start position of the content information (step S1).

Next, the processor 207 outputs the recording signal Sr inputted from the external input terminal (not shown) of the information recording device 200 to the encoder 208 (step S2).

Next, the encoder 208 generates the unit sector 110 in the data sector based on the recording signal Sr (step S3). To be specific, the encoder 208 substitutes the data corresponding to the recording signal Sr in the main data region of the unit sector 110 having the array structure of 172 bytes×12 rows as illustrated in FIG. 2 and substitutes the ID, the IED, the RSV, and the EDC in the ID region 112, the IED region 113, the RSV region 114, and the EDC region 116, respectively. Furthermore, the encoder 208 substitutes the additional information based on the random numbers in the additional information region 115 to thus generate the data sector.

In order to substitute the additional information in the additional information region 115, first, a processor (not shown) included in the encoder 208 generates a random number. According to the present embodiment, as illustrated in FIG. 3, since the additional information region 115 has one byte, the generated random number ranges from 0 to 255. Next, the information obtained by representing the generated random number by a binary system as the additional information is substituted in the additional information region 115.

Next, the encoder 208 generates the ECC block 120 based on the unit sector 110 generated in step S3 (step S4). To be specific, the encoder 208 combines 16 units of the unit sector 110, each having 172 bytes (columns) ×12 rows, to thus generate the array structure of 172 bytes (columns) ×192 rows. Then, the PO parity 121 of 16 bytes is added to each of the 172 columns and the PI parity 122 of 10 bytes is added to each of the 208 rows including the PO parity 121 to thus generate the ECC block 120.

Next, the encoder 208 generates the recording sector 130 based on the ECC block 120 generated in step S4 (step S5). To be specific, the encoder 208 interleaves each row of the PO parity 121 of 16 rows in the last line of each unit sector 110 in the ECC block 120 to thus generate the recording sector 130 as illustrated in FIG. 5.

Next, the encoder 208 generates the physical sector 140 based on the recording sector 130 generated in step S5 and outputs the encoded signal Sre based on the corresponding physical sector 140 (step S6).

To be specific, the encoder 208 divides each row equally into two parts so that each of the divided rows has 91 bytes in the recording sector 130 of 182 bytes×13 rows and adds the sync codes 141 to the fronts of the respective rows. According to the present embodiment, in adding the sync code 141, the encoder 208 detects a potential level (0 or 1) in the final position of the divided data positioned immediately before the position to which the sync code 141 is added and selects the sync code 141 having any one sync detector of two kinds of sync detectors based on the detected potential level. For example, when the detected potential level is 0, the sync code 141 including the sync detector formed by the composition of 14T and 4T is selected. When the detected potential level is 1, the sync code 141 including the sync detector formed by the combination of 16T and 3T is selected. Then, the selected sync code 141 is added to the corresponding position.

Further, the encoder 208 repeats the corresponding operation with respect to the data equally divided into two parts of each row and adds the sync codes 141 to the fronts of all of the data divided equally into two parts.

Next, the encoder 208 performs 8/16 modulation of the information to which the sync codes 141 are added using the modulation table illustrated in FIGS. 7A and 7B to thus generate the physical sector 140 as illustrated in FIG. 6 and outputs the encoded signal Sre based on the corresponding physical sector 140.

Next, the power control circuit 209 forms the recording marks M or the spaces S in the DVD-RW 100 based on the encoded signal Sre outputted in step S6 (step S7). To be specific, the power control circuit 209 controls the laser driving circuit 210 to thus emit a predetermined laser beam B from the pick-up 201 and forms predetermined recording marks M and spaces S in the DVD-RW 100 by the corresponding laser beam B based on the encoded signal Sre (step S7).

Then, it is determined whether recording of all of the content information is completed (step S8). When the recording of all of the content information is not completed, the above-mentioned process is repeated. When the recording of all of the content information is completed, the recording process is terminated.

(3-2) Reproducing Process

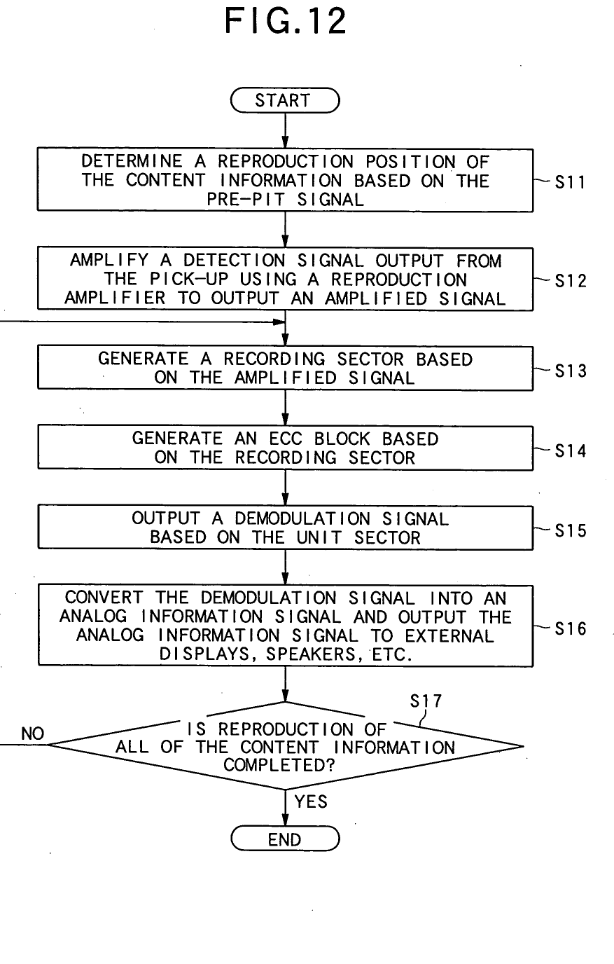

Next, the process of reproducing the content information recorded in the DVD-RW 100 using the recording and reproducing device 200 are described with reference to FIG. 12. FIG. 12 is a flowchart illustrating the order of the reproducing process of the content information.

First, the processor 207 of the information recording device 200 detects a pre-address based on the pre-pit signal of the DVD-RW 100 to thus determine the reproducing start position of the content information (step S11).

Next, the pick-up 201 radiates the laser beam B onto an optical disk 100 and receives the reflected light from the DVD-RW 100 for the radiated beam to thus output the detection signal Sdt in accordance with the intensity of received light. The reproduction amplifier 202 amplifies the detection signal Sdt to a predetermined level to thus output the amplified signal Sp (step S12).

Next, the decoder 203 generates the recording sector 130 based on the amplified signal Sp (step S13).

To be specific, the decoder 203, first, performs 8/16 demodulation using the modulation table illustrated in FIGS. 7A and 7B. Then, the decoder 203 performs synchronization by detecting the sync code 141 among the data after the 8/16 demodulation to thus generate the recording sector 130. A sync code detecting portion (not shown) included in the decoder 203 detects the sync code 141. The sync code detecting portion detects the corresponding region as the sync code 141 when any one of the two kinds of sync detectors illustrated in FIGS. 9A and 9B is detected.

Next, the decoder 203 generates the ECC block 120 based on the recording sector 130 generated in step S13 (step S14). To be specific, the decoder 203 combines 16 sectors of the recording sector 130 and interleaves the PO parity 121 in the combined recording sector 130 to thus generate the data sector.

Next, the decoder 203 generates the unit sector 110 based on the ECC block 120 generated in step S14 and outputs a demodulated signal Sdm based on the corresponding unit sector 110 (step S15). To be specific, the decoder 203 performs error correction using the PO parity 121 and the PI parity 122 of the ECC block 120 and generates the unit sector 110 by dividing the ECC block 120 into sixteen. Then, the decoder 203 outputs the demodulated signal Sdm to the processor 207 based on the generated unit sector 110.

Next, the processor 207 converts the demodulated signal Sdm into an analog information signal with a D/A converter (not shown) and outputs the analog information signal to external displays and speakers (step S16).

Then, it is determined whether reproducing of all of the content information is completed (step S17). When the reproducing of all of the content information is not completed, the above-mentioned process is repeated. When the reproducing of all of the content information is completed, the corresponding reproducing process is terminated.

(4) Modification

Further, according to the above-mentioned embodiment, the DVD-RW 100 is used as the overwritable recording medium. However, without being limited to this, recording medium of a magneto-optical recording method such as a magneto-optical disc (MO) and a mini disc (MD) can be used as the overwritable recording medium.

In addition, according to the above-mentioned embodiment, the encoder 208 included in the recording and reproducing device 200 functions as the recording information generating means and the pick-up 201, the power control circuit 209, and the laser driving circuit 210 function as the recording portion forming means. However, the processor 207 included in the recording and reproducing device 200 may function as the respective means by a computer program stored in a ROM.

Furthermore, the present invention is not limited to the above-mentioned embodiments, and various changes and variations may be made without departing from the spirit and scope of the invention as defined by the appended claims.

As explained above, according to the present embodiment, the plurality of recording marks M and spaces S are formed based on the physical sector 140 generated by combining desired content information and the additional information that changes whenever the content information is recorded in the DVD-RW 100 in the overwritable DVD-RW 100.

Therefore, even if a part of the content information is the same, since the physical sector 140 is changed in accordance with changes in the additional information and since the recording marks M and the spaces S are formed based on the corresponding physical sector 140, it is possible to prevent the edges E of the recording marks M and the spaces S from overlapping, to prevent the edges E of the recording marks M and the spaces S from being blurred, and to thus significantly improve the quality of the DVD-RW 100.

In addition, in the DVD-RW 100, the recording sector 130 is generated by the content information and the additional information that changes based on the random numbers, and the plurality of recording marks M and spaces S are formed based on the generated recording sector 130.

Therefore, since the additional information is generated based on the random numbers, it is possible to change the contents of the additional information at random and to further enhance the above-mentioned operational effects.

Also, in the DVD-RW 100, the content information and the additional information are combined by performing error-correction coding to thus generate the physical sector 140, and the plurality of recording marks M and spaces S are formed based on the generated physical sector 140.

Therefore, since it is possible to change the PO parity 121 and the PI parity 122 generated by the error-correction coding in accordance with changes in the additional information and to thus change the physical sector 140, it is possible to further enhance the above-mentioned operational effects.

In addition, in the DVD-RW 100, the 8/16 modulation is performed after the error-correction coding is made to thus generate the physical sector 140, and the plurality of recording marks M and spaces S are formed based on the physical sector 140.

Therefore, since it is possible to further change the physical sector 140 by the 8/16 modulation and to thus enhance the above-mentioned operation effects.

Also, according to the present embodiment, the recording device 200 records desired content information in the DVD-RW 100, and includes the encoder 208 for adding the content information and the additional information that changes whenever the content information is recorded in the DVD-RW 100 to thus generate the physical sector 140, the pick-up 201, the power control circuit 209, and the laser driving circuit 210 for forming the plurality of recording marks M and spaces S in the DVD-RW 100.

Therefore, even if a part of the content information is the same, since it is possible to change the physical sector 140 in accordance with changes in the additional information and to form the recording marks M and the spaces S based on the physical sector 140, it is possible to prevent the edges E of the recording marks M and the spaces S from overlapping, to prevent the edges E of the recording marks M and the spaces S from being blurred, and to thus significantly improve the quality of the DVD-RW 100.

Also, according to the present embodiment, a method of recording desired content information in the DVD-RW 100 includes a recording information generating process of adding the content information and the additional information that changes whenever the content information is recorded in the DVD-RW 100 to thus generate the recording information and a recording mark forming process of forming the plurality of recording marks M and spaces S in the recording medium based on the recording information.

Therefore, even if a part of the content information is the same, since it is possible to change the physical sector 140 in accordance with changes in the additional information and to form the recording marks M and the spaces S based on the physical sector 140, it is possible to prevent the edges E of the recording marks M and the spaces S from overlapping, to prevent the edges E of the recording marks M and the spaces S from being blurred, and to thus significantly improve the quality of the DVD-RW 100.

It should be understood that various alternatives to the embodiment of the invention described herein may be employed in practicing the invention. Thus, it is intended that the following claims define the scope of the invention and that methods and structures within the scope of these claims and their equivalents be covered thereby.

The entire disclosure of Japanese Patent Application No. 2003-206524 filed on Aug. 7, 2003 including the specification, claims, drawings and summary are incorporated herein by reference in its entirety.

1. An overwritable recording medium comprising:
desired content information;
additional information that changes whenever the content information is recorded in the recording medium; and
a plurality of recording patterns which are formed based on recording information generated by combining the desired content information and the additional information.

2. The recording medium according to claim 1,
wherein the recording information is generated by the content information and the additional information that changes based on random numbers, and
wherein the recording patterns are formed based on the generated recording information.

3. The recording medium according to claim 1,
wherein the recording information is generated by combining the content information and the additional information by error-correction coding, and
wherein the recording patterns are formed based on the generated recording information.

4. The recording medium according to claim 3,
wherein the recording information is generated by performing modulation after the error-correction coding is made, and
wherein the recording patterns are formed based on the recording information.

5. A recording device for recording desired content information in an overwritable recording medium, the recording device comprising:
a recording information generating device which generates recording information for combining the content information and the additional information that changes whenever the content information is recorded in the recording medium; and
a recording pattern forming device which forms a plurality of recording patterns in the recording medium based on the recording information.

6. A method of recording desired content information in an overwritable recording medium, the method comprising:
a recording information generating process of generating recording information for combining the content information and the additional information that changes whenever the content information is recorded in the recording medium; and
a recording pattern forming process of forming a plurality of recording patterns in the recording medium based on the recording information.

7. A recording program for recording desired content information in an overwritable recording medium by a computer, the recording program making the computer functional as:
a recording information generating device which generate recording information for combining the content information and the additional information that changes whenever the content information is recorded in the recording medium; and
a recording pattern forming device which forms a plurality of recording patterns in the recording medium based on the recording information.

8. An information recording medium in which a recording program is recorded in a readable way by a computer included in a recording apparatus which, the information recording program causing the computer to function as:
a recording information generating device which generate recording information for combining the content information and the additional information that changes whenever the content information is recorded in the recording medium; and
a recording patterns forming device which forms a plurality of recording patterns in the recording medium based on the recording information.
